(19) United States
(12) Patent Application Publication
(10) Pub. No.: US 2010/0153551 A1
(43) Pub. Date: Jun. 17, 2010

(54) METHOD OF MANAGING NON-IP BASED SENSOR NETWORK USING SIMPLE NETWORK MANAGEMENT PROTOCOL

(75) Inventors: Eunsook KIM, Daejeon-city (KR); Jun Seob Lee, Daejeon-city (KR); Yong Woon Kim, Daejeon-city (KR); Hyoung Jun Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/565,913

(22) Filed: Sep. 24, 2009

(30) Foreign Application Priority Data
Dec. 16, 2008 (KR) 10-2008-0128175

(51) Int. Cl. G06F 15/173

(52) U.S. Cl. 709/225

(57) ABSTRACT

Provided is a method of managing a non-IP sensor network using a simple network management protocol (SNMP), and more particularly, a method of remotely managing a non-IP based sensor network, such as Zigbee, from the Internet of a sensor network manager.

### CROSS-REFERENCE TO RELATED PATENT APPLICATION

This application claims the benefit of Korean Patent Application No. 10-2008-0128175, filed on Dec. 16, 2008, in the Korean Intellectual Property Office, the disclosure of which is incorporated herein in its entirety by reference.

### BACKGROUND OF THE INVENTION

1. Field of the Invention

The present invention relates to a method of managing a non-IP sensor network using a simple network management protocol (SNMP), and more particularly to, a method of remotely managing a non-IP based sensor network, such as Zigbee, from the Internet of a sensor network manager.

2. Description of the Related Art

A simple network management protocol (SNMP) is a protocol that is used in a network management system to monitor network-attached devices as part of transmission control protocol/Internet protocol (TCP/IP).

FIG. 1 illustrates a conventional network management using the SNMP. The SNMP is used to communicate a network manager 110 and a managed agent 120. The network manager 110 uses the SNMP to search for information about the managed agent 120 and to change setting of a management information base (MIB) table.

FIG. 2 illustrates conventional interoperability between the Internet using the SNMP and a sensor network 220. Referring to FIG. 2, sensor networks may be classified into IP-based sensor networks that use IP addresses and perform an IP communication and non-IP based sensor networks that use media access control (MAC) addresses or abbreviated addresses other than IP addresses and do not perform the IP communication.

For an IP-based sensor network, a sensor network manager 210 can directly manage a sensor node by using an IP address. The management items of the managed sensor nodes are definitions of an MIB table. The sensor network manager 210 can directly request or update the value of the management items by using the IP address of the sensor node. The objects to be managed by the sensor network manager 210 may remarkably increase in a sensor network. Thus, it must be considered to extend management items in the MIB table.

However, for a non-IP sensor network, the sensor network manager 210 cannot directly communicate with a sensor node, as non-IP based sensor network uses a MAC address or an abbreviated address, other than the IP address, and does not perform IP communication. Considering that the applications and services of non-IP based sensor networks are evolving in a way to be integrated in the Internet, the remote management of non-IP sensor networks and the interoperation are essential. Especially, it is important to provide a method of managing a non-IP sensor networks in a sensor network manager 210 without using many management protocols for different types of sensor networks and without changing its major management protocol, when most sensor networks are non-IP based sensor networks and IP based sensor networks are just being developed.

### SUMMARY OF THE INVENTION

The present invention provides a method of managing a non-IP based sensor network by a sensor network manager accessing the Internet, by using a simple network management protocol (SNMP) without an additional protocol.

In general, the SNMP interoperates with the managed targets using IP address, and the SNMP messages include ID for managed objects. However, for management of non-IP based sensor networks, the sensor network manager using SNMP cannot directly reach to sensor nodes using non-IP addresses. According to an aspect of the present invention, there is provided a method of managing a non-IP based sensor network using a simple network management protocol (SNMP), the method including: defining a new set of managed object identifiers indicating an object identification for node address and its address value in front of normal object identification set sequence; generating an SNMP message including object identification set sequence followed by the newly defined default set of object identification consisting of an object identifier for a sensor node address and its non-IP address value; transmitting the SNMP message to the sensor node through a sensor network management agent which bridging non-IP based sensor network and internet based sensor network manager; and receiving a response SNMP message from the sensor node.

The sensor network management agent may be logically or physically connected to a gateway having a predetermined IP address value.

The SNMP message may be transmitted to the sensor node by using an IP value of the sensor network management agent and includes the node address identifier indicating the address information management of the sensor node among the defined set of managed object identifiers, the address value of the sensor node, and the inquiring object identifier indicating the management items for the sensor node.

The sensor network management agent may extract the node address identifier and the address value of the sensor node, and analyzes the inquiry of the object identifier set sequences following after the default object identifier set.

The response SNMP message may include the node address identifier and the address value of the sensor node, and responds to the managed object value of the required management items for the sensor node.

The trap message may be used by the non-IP sensor network in order to report a change in a link and topology of the non-IP based sensor network to the sensor network manager.

The non-IP based sensor network may be a non-IP based sensor network such as Zigbee.

The address value of the sensor node may be a media access control (MAC) type non-IP address value or an abbreviated type non-IP address value.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional network management using a simple network management protocol (SNMP);

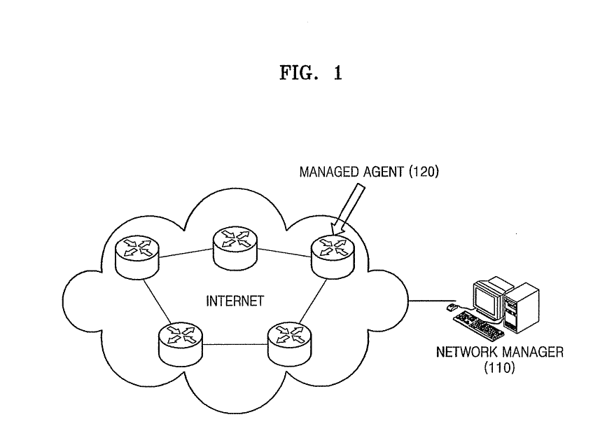

FIG. 2 illustrates conventional interoperability between the Internet using a SNMP and a sensor network;

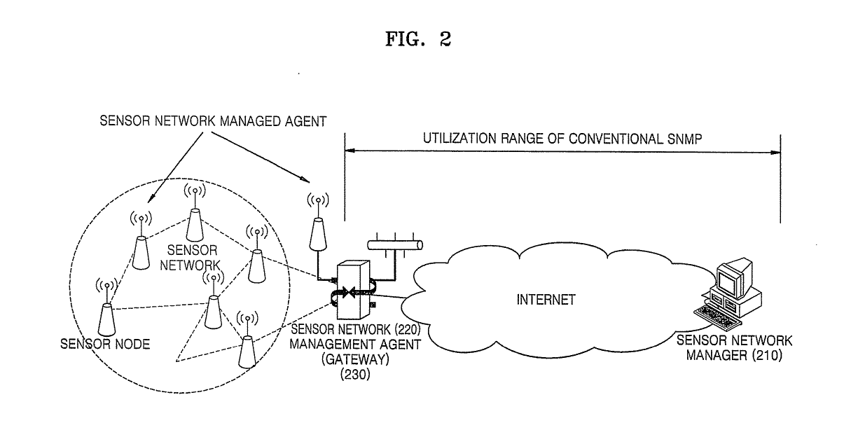

FIG. 3 illustrates a non-IP based sensor network management using a SNMP according to an embodiment of the present invention;

FIG. 4 illustrates a structure of a SNMP message according to an embodiment of the present invention;

FIG. 5 illustrates a non-IP based sensor network management using a SNMP according to another embodiment of the present invention;

FIG. 6 illustrates a structure of a SNMP message according to another embodiment of the present invention;

FIG. 7 illustrates a non-IP based sensor network management using a SNMP according to another embodiment of the present invention; and

FIG. 8 illustrates a non-IP based sensor network management using a SNMP according to another embodiment of the present invention.

### DETAILED DESCRIPTION OF THE INVENTION

The present invention will now be described more fully with reference to the accompanying drawings, in which exemplary embodiments of the invention are shown.

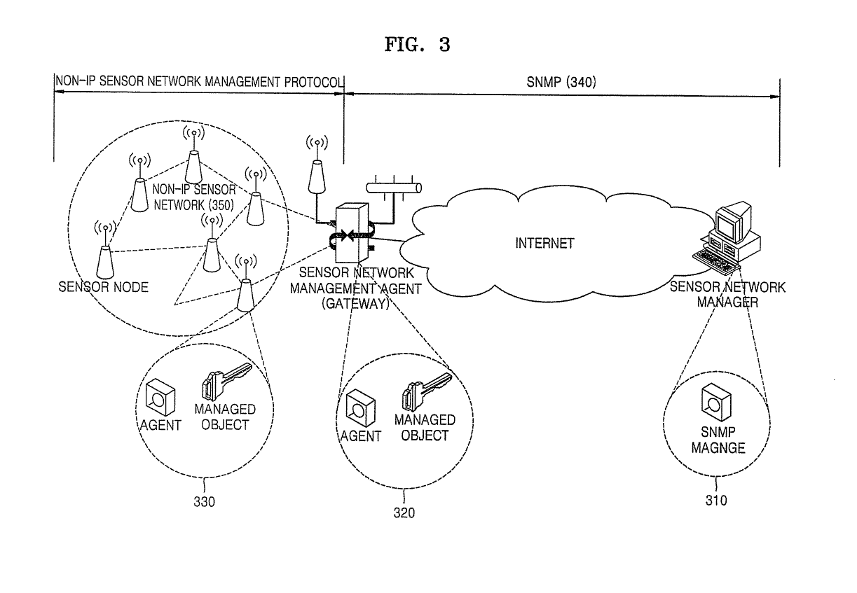

FIG. 3 illustrates a non-IP based sensor network management using a simple network management protocol (SNMP) according to an embodiment of the present invention.

The present embodiment provides a method of managing a sensor node in an IP based network manager that is remotely placed without changing the SNMP in order to manage a non-IP based sensor network.

Referring to FIG. 3, a sensor network manager SNMGR 310 that is connected to the Internet, a sensor network management agent SNMGA 320 that is logically or physically placed in a gateway connected to an IP network and a non-IP sensor network, and a sensor network management node agent SNMNA 330 that is an agent on a sensor node which is a non-IP sensor network are used to manage a non-IP based sensor network 350 by using the SNMP.

The sensor network management agent SNMGA 320 manages information of an individual node included in a sensor network.

The sensor network management agent SNMGA 320 is a logic object and may be included in a gateway or another physical system.

In the present embodiment, managed object identifiers that indicate management items of each sensor node must be previously defined in order to manage the non-IP based sensor network 350 by using the SNMP.

The defined managed object identifiers are included in a management information base (MIB) table used to manage the sensor network.

A structure of the MIB table is not provided in the present embodiment since it is not an objective of the present invention.

Table 1 indicates an example of the defined managed object identifiers.

TABLE 1

| Managed | |
|---|---|
| Object ID | Description |
| SNInfo | Basic information of a corresponding sensor |
| | network - information about {SN-ID, address |
| | systems (16 bit, 64 bit, etc: these are all non-IP |
| | addresses), security method (if any)} |
| SNConfigInfo | address information of all nodes of a corresponding |
| | sensor network - list of NodeConfigInfo |
| NodeConfigInfo | address information of a single node - information |
| | {NodeAddr, power supply method(battery/power), |
| | Role, parent node address} |
| SNStatusInfo | status information of all nodes of a corresponding |
| | sensor network - list of NodeStatusInfo |
| NodeStatusInfo | Status information of a single node - information |
| | {NodeAddr, Role, PowerLevel} |
| NodeAddr | Address information of sensor node |
| Role | role information of sensor node |
| PowerLevel | Power level information of sensor node |

The present embodiment provides a method of obtaining information about a target sensor node for specific management and a method of managing an obtained target objects of the sensor node when the managed target node of a sensor network does not have an IP address.

The non-IP based sensor network 350 needs to solve the way to obtain the information about the non-IP based sensor node, while it is not a problem in IP based sensor networks as a SNMGR 310 simply refers IP address of a target node.

The information for each sensor node is obtained through the sensor network management agent SNMGA 320.

In general, a sensor network is built with an association between a gateway or a head node of the sensor network and other sensor nodes attached to the sensor network. (e.g., an example of a head node is a PAN coordinator in an IEEE 802.15.4 based network such as Zigbee)

In this process, the head node of the sensor network obtains and manages information about the sensor network.

The sensor network management agent SNMGA 320 that is logically or physically connected to a gateway system obtains and manages an address value and positioning (location) information in a network topology for each sensor node.

The sensor network management node agent SNMNA 330 communicates with the sensor network management agent SNMGA 320.

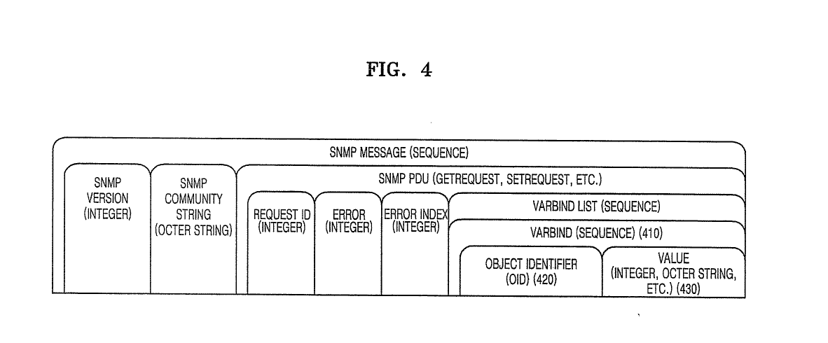

FIG. 4 illustrates a structure of a SNMP message according to an embodiment of the present invention.

Referring to FIG. 4, the SNMP message includes GetRequest-PDU, GetNextRequest-PDU, GetResponse-PDU, SetRequest-PDU, GetBulkRequest-PDU, and Trap-PDU.

A VarBind field 410 includes the managed object identifiers such as defined in Table 1 and management object values.

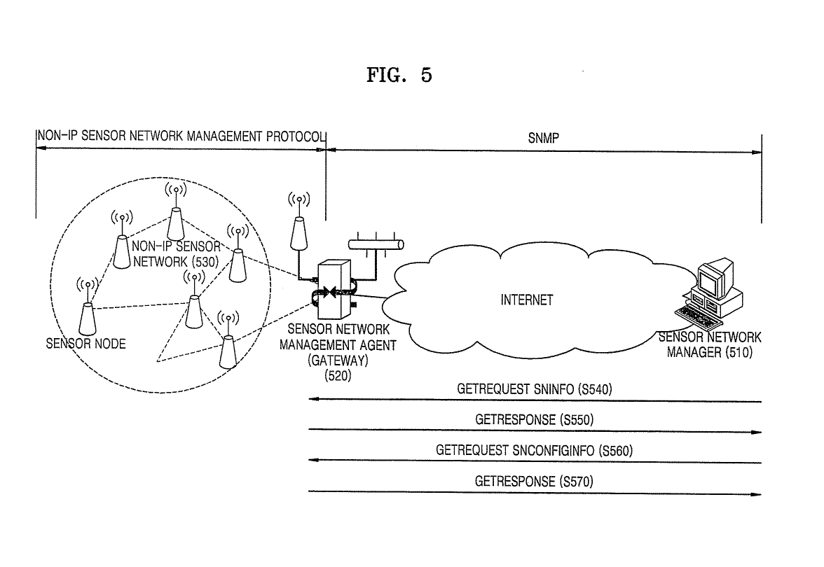

FIG. 5 illustrates a non-IP based sensor network management using a SNMP according to another embodiment of the present invention.

The present embodiment provides a method of exchanging the managed object identifiers such as defined in Table 1 between a sensor network manager SNMGR 510 that is connected to the Internet and a sensor node of Non-IP Sensor network 530.

In operation 540, the sensor network manager SNMGR 510 transmits a SNMP message, GetRequest SNInfo requesting basic information about a Non-IP based sensor network 530, such as an address structure or a security method, to an IP address of a sensor network management agent SNMGA 520.

In operation 550, the sensor network management agent SNMGA 520 stores a value (e.g., 16 bit or 64 bit) of the address structure in a value field 430 shown in FIG. 4 and sends a SNMP message, GetResponse to the sensor network manager 510.

GetResponse SNMP message 560 is an answer to the GetRequest SNInfo inquiring an address value.

In operation 560, the sensor network manager SNMGR 510 transmits a SNMP message, GetRequest SNConfigInfo that is the managed object identifiers defined in Table 1 to the sensor network management agent SNMGA 520 in order to obtain address information of all nodes of a Non-IP sensor network 530.

In operation 570, the sensor network management agent SNMGA 520 stores address information of all nodes in a Non-IP sensor network 530, and sends an SNMP message, GetResponse to the sensor network manager 510.

GetResponse SNMP message 570 is an answer to the GetRequest SNConfigInfo which inquires address information of all nodes of a Non-IP sensor network 530.

The sensor network manager SNMGR 510 can obtain non-IP addresses of all sensor nodes through operations 540 through 570 and calculate the node topology information including parents-children relationship.

A special role may be provided to specific nodes according to a network application objective.

The sensor network manager SNMGR 510 obtains information about a node role for power management and congestion control.

Although the sensor network manager SNMGR 510 that is connected to the Internet has obtained an non-IP address value of each sensor node, the sensor network manager SNMGR 510 cannot directly inquire a status of a specific sensor node or directly set up some management information about a specific node, since SNMP use IP address for peer to peer communication.

In the IP based sensor network, the SNMP used by the sensor network manager SNMGR 510 transmits a managed object identifiers to an IP address of a sensor node included in a managed object.

However, since each sensor node has a non-IP address in the non-IP based sensor network, the sensor network manager SNMGR 510 needs to call a non-IP sensor node without changing the SNMP.

For example, it is assumed that the sensor network manager 510 desires to obtain a power level of a sensor node A.

The sensor network manager SNMGR 510 transmits a GetRequest SNMP message to the sensor node A according to a SNMP message rule in the IP based sensor network.

GetRequest [recipient: IP address of A, {PowerLevel, NULL}]

The sensor node A sends GetResponse[{PowerLevel, 50}] in response to GetRequest SNMP message of the sensor network manager SNMGR 510.

In more detail, if the sensor network manager SNMGR 510 sends the GetRequest SNMP message including a null value in the IP based sensor network in order to request a value of the corresponding managed object identifier (OID) such as {OID, NULL}, the sensor node A sends GetResponse[{PowerLevel, 50}] including the value of the corresponding OID.

However, the sensor network manager SNMGR 510 cannot use the non-IP address of the senor node A in the non-IP based sensor network.

Therefore, the sensor network manager SNMGR 510 must use an IP address of a sensor network management agent SNMGA 520, which is the only IP address to connect the sensor network manager SNMGR 510 and a non-IP sensor network 530.

However, the sensor network manager SNMGR 510 cannot use the general rule of SNMP messages in this case (e.g., the same example of GetRequest [recipient: IP address of SNMGA 520, {PowerLevel, NULL}] to obtain a power level of a sensor node A in the Non-IP based sensor network).

The reason is that GetRequest [recipient: IP address of SNMGA 520, {PowerLevel, NULL}] message is not an inquiry of PowerLevel of the sensor node A but an inquiry of PowerLevel of the sensor network management agent SNMGA 520.

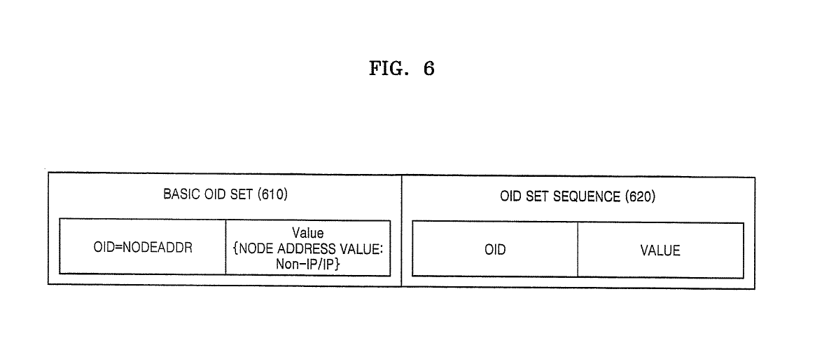

FIG. 6 illustrates a structure of a SNMP message according to another embodiment of the present invention.

Since the sensor network manager SNMGR 510 does not directly communicate with a non-IP sensor node, the sensor network manager SNMGR 510 communicates with the non-IP sensor node through an IP address of the sensor network management agent SNMGA 520 by using a newly defined managed object identifier (OID) set including an object identifier for a sensor node address and the value of the address in order to call an individual sensor node having the non-IP address using the defined managed object identifier set. Thus, this newly defined managed object identifier set must be included in SNMP messages as default.

Referring to FIG. 6, the SNMP message includes the default OID set 610 and OID set sequence 620 to manage a non-IP based sensor network.

The default OID set 610 defines NodeAddr as a managed OID indicating a node address of the Non-IP address.

For the same task to obtain a power level of a sensor node A, the SNMP message GetRequest[IP address of SNMGA, {NodeAddr, A}, {PowerLevel, NULL}] is used by the sensor network manager SNMGR 510.

That is, the SNMP message includes the IP address of the sensor network management agent SNMGA 520, a managed object identifier, NodeAddr, indicating the identification of a sensor node, and the address value of the sensor node A that is a managed agent 610.

Upon receipt of the SNMP message, the sensor network manager SNMGR 510 transmits the inquiry to the sensor node A.

It should be noticed that, in the present embodiment, the SNMP message already includes the value of the OID for node address, in a form of {OID(NodeAddr), value of NodeAddr}, while in general, the GetRequest SNMP message uses {OID, NULL} format to request the value of the targeted OID, then the corresponding GetResponse is returned with filling up the value of the OID.

After a special form of the default set of OID, an actually inquiring OID, such as PowerLevel, is following a general form of {OID(PowerLevel), NULL}. The OID set sequences are transmitted to the IP address of the sensor network management agent SNMGA 520.

The sensor network management agent SNMGA 520 transfers request information to the sensor network management node agent SNMNA 330 of FIG. 3.

The request information transferred to the sensor network management node agent SNMNA 330 does not use an IP address as a key value but the non-IP address value used in a corresponding sensor network.

In more detail, the sensor network manager SNMGR 510 sends the SNMP message GetRequest[IP address of SNMGA, {NodeAddr, A}, {PowerLevel, NULL}] to the sensor network management agent SNMGA 520 and the sensor network management agent SNMGA 520 sends GetRequest[A, {PowerLevel, NULL}] to the sensor network management node agent SNMNA 330 of FIG. 3.

The sensor network management node agent SNMNA 330 of FIG. 3 sends a response message including a current power level in the NULL value field to the sensor network management agent SNMGA 520.

When the current power level is assumed as 2, the sensor network management node agent SNMNA 330 of FIG. 3 sends a message GetResponse [A, {PowerLevel, 2}].

This method which uses the same SNMP message format in non-IP based sensor networks except IP address provides that sensor network management agents can use the uniformed methods for message encoding and decoding. The GetResponse SNMP message received from the sensor network management agent SNMGA 520 in response to the sensor network manager SNMGR 510 includes the default OID set 610, the OID set sequence 620, the managed object ID (OID), and the specific value for the requested OID.

That is, the sensor network management agent SNMGA 520 that receives a response message from the sensor node A sends GetResponse [IP address of SNMGA, {NodeAddr, A}, {PowerLevel, 2}] to the sensor network manager SNMGR 510.

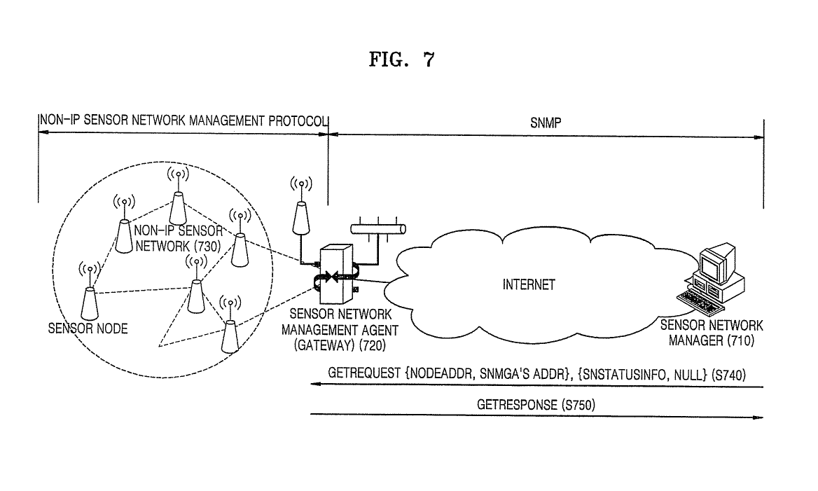

FIG. 7 illustrates a non-IP based sensor network management using a SNMP according to another embodiment of the present invention.

If a sensor network manager SNMGR 710 inquires status information about all nodes to a sensor network management agent SNMGA 720 other than a specific sensor node, a GetRequest SNMP message is transmitted below.

In operation 740, the default OID set 610 of FIG. 6 is {NodeAddr, address of SNMGA}, and the OID set sequence 620 transmits {OID, NULL} that are a managed object ID (OID) and a NULL value.

A value of the managed object ID is null in order to request the sensor network management agent SNMGA 720 for a value of the corresponding OID.

In more detail, a GetRequest SNMP message sent from the sensor network manager SNMGR 710 to the sensor network management agent SNMGA 720 is GetRequest[{NodeAddr, address of SNMGA}, {PowerLevel, NULL}].

In operation 750, the sensor network management agent SNMGA 720 sends a GetResponse SNMP message including the default OID set 610 as {NodeAddr, address of SNMGA} and the managed OID and a response value as {OID, value}.

That is, the GetRespnse message includes a value of a corresponding OID.

The GetResponse SNMP message sent from the sensor network management agent SNMGA 720 to the sensor network manager SNMGR 710 is GetResponse[{NodeAddr, address of SNMGA}, {PowerLevel, value}].

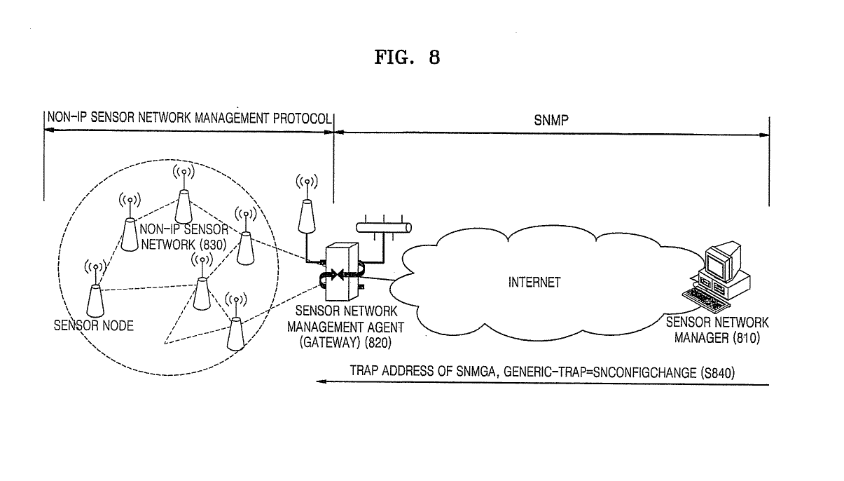

FIG. 8 illustrates a non-IP based sensor network management using a SNMP according to another embodiment of the present invention.

A single sensor network, which includes dynamic and low power sensor nodes, has the characteristic to operate as a set.

Although no request is made from a sensor network manager, the dynamically changing information about the sensor network is recommended to be transferred to the sensor network manager on a regular basis.

A sensor network management agent SNMGA 820 may utilize a TRAP message of SNMP in order to provide information about the updated information of the status of the sensor network.

A link change status may be known by utilizing a Generic-trap message of SNMP such as linkDown or linkUp.

However, linkDown or linkUp is designed to suitably report a status of a specific node such as router over the Internet. The sensor network that dynamically changes requires a method of managing the entire sensor network other than the specific node.

That is, a link of the entire sensor network must not be disconnected or recovered when one or a couple of link has been changed inside the sensor network.

Although a long or short link loss occurs in one or two nodes of the sensor network, it must not be reported that the link of the entire sensor network is down but it is reported that a node relation of a corresponding part is changed.

In operation 840, a sensor network manager SNMGA 810 sends a TRAP message of SNMP to a sensor network management agent SNMGA 820 in order to provide information about the whole network status.

The information of sensor node configuration such as information defined in Table 1 can be added in the Generic-Trap value of SNMP TRAP PDU for a periodic report of the sensor network status.

A method of managing a sensor network according to the present invention does not depend on an additionally necessary managed object and an ID thereof besides the managed object with regard to the obtained address information about the entire sensor nodes.

A method of managing a non-IP based sensor network using a SNMP according to the present invention can be used to easily manage the non-IP based sensor network. In more detail, a sensor network manager accessing the Internet can manage each sensor node included in the non-IP sensor network using the SNMP without an additional protocol.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing a non-IP based sensor network using a simple network management protocol (SNMP), the method comprising:
defining a plurality of managed object identifiers indicating management items of each sensor node included in the non-IP based sensor network;
generating a SNMP message including a defined default set of managed object identifier consisting of an object identifier indicating address identification of a sensor node and the address value of the sensor node, and managed object identifier set sequence for inquiry of specific management items of the sensor node;
transmitting the SNMP message to the sensor node; and
receiving a response SNMP message from the sensor node.

2. The method of claim 1, wherein the SNMP message is transmitted to the sensor node through a sensor network management agent that connects the non-IP based sensor network and the Internet.

3. The method of claim 2, wherein the sensor network management agent is logically or physically connected to a gateway having a predetermined IP address value.

4. The method of claim 3, wherein the SNMP message is transmitted to the sensor node by using an IP value of the sensor network management agent and includes the node address identifier indicating the address information management of the sensor node and the address value of the sensor node in the defined default object identifier set, and the inquiring object identifier set sequence indicating the management items to manage the sensor node.

5. The method of claim 2, wherein the sensor network management agent extracts the node address identifier and the address value of the sensor node, and analyzes the inquiry of the left object identifier set sequence.

6. The method of claim 1, wherein the SNMP message uses a non-IP address value of the non-IP based sensor network in order to obtain a managed object value of the management items requiring to manage the sensor node.

7. The method of claim 1, wherein the response SNMP message includes the node address identifier and the address value of the sensor node, and responds to the managed object value of the management items of the sensor node.

8. The method of claim 1, wherein the SNMP message uses a Trap message in order to report a status change such as a link and topology change of the non-IP based sensor network.

9. The method of claim 1, wherein the non-IP based sensor network is a non-IP based sensor network such as Zigbee.

10. The method of claim 1, wherein the address value of the sensor node is a media access control (MAC) address value or an abbreviated type of non-IP address value.
